(19) United States
(12) Patent Application Publication
(10) Pub. No.: US 2016/0085219 A1
(43) Pub. Date: Mar. 24, 2016

(54) SCHEDULING APPLICATIONS IN PROCESSING DEVICES BASED ON PREDICTED THERMAL IMPACT

(71) Applicant: Advanced Micro Devices, Inc., Sunnyvale, CA (US)

(72) Inventors: Indrani Paul, Round Rock, TX (US); Manish Arora, Dublin, CA (US); Yasuko Eckert, Kirkland, WA (US); Srilatha Manne, Portland, OR (US)

(21) Appl. No.: 14/493,189

(22) Filed: Sep. 22, 2014

(51) Int. Cl. G05B 15/02; G06N 5/04

(52) U.S. Cl. CPC G05B 15/02; G06N 5/04

(57) ABSTRACT

A processing device includes a plurality of components and a system management unit to selectively schedule an application phase to one of the plurality of components based on one or more comparisons of predictions of a plurality of thermal impacts of executing the application phase on each of the plurality of components. The predictions may be generated based on a thermal history associated with the application phase, thermal sensitivities of the plurality of components, or a layout of the plurality of components in the processing device.

### BACKGROUND

1. Field of the Disclosure

The present disclosure relates generally to processing devices and, more particularly, scheduling applications in processing devices.

2. Description of the Related Art

Processing devices such as systems-on-a-chip (SoCs) include a variety of components that may have different sizes and processing capabilities. For example, a heterogeneous SoC may include a combination of one or more small central processing unit (CPUs) or CPU cores, one or more large CPUs or CPU cores, one or more graphics processing units (GPUs), or one or more accelerated processing units (APUs). Larger components may have higher processing capabilities that support larger throughputs, e.g., higher instructions per cycle (IPCs), as well as implementing larger prefetch engines, better branch prediction algorithms, and the like. However, the increased capabilities come at the cost of increased power consumption, greater heat dissipation, and potentially more rapid aging caused by the higher operating temperatures resulting from the greater heat dissipation. Smaller components may have correspondingly lower processing capabilities, smaller prefetch engines, less accurate branch prediction algorithms, etc., but may consume less power, dissipate less heat than their larger counterparts, and age less rapidly.

Operation of the components of the SOC generates heat, which raises the temperature of the SOC. Conventional power management algorithms attempt to maintain the operating temperature of the SOC within a predetermined range using temperatures measured by one or more temperature sensors at different locations around the substrate. The power management algorithms can adjust the operating frequency or operating voltage of the SOC so that the measured temperature does not exceed a maximum temperature at which heat dissipation may damage the SOC. For example, a power management algorithm may increase the operating frequency of the SOC until the temperature measured by one or more temperature sensors approaches the maximum temperature. The power management algorithm may then maintain or decrease the operating frequency of the SOC to prevent the temperature from exceeding the maximum temperature. Conventional power management algorithms are therefore reactive, i.e., they react to changes in temperature caused by operation of components of the SOC. Consequently, conventional power management algorithms are unable to anticipate excessive temperatures or thermal emergencies.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device in accordance with some embodiments.

FIG. 2 is a contour plot of a thermal density map for a processing device such as the processing device shown in FIG. 1 according to some embodiments.

FIG. 3 is a contour plot of a thermal density map for a processing device such as the processing device shown in FIG. 1 according to some embodiments.

FIG. 4 is a block diagram of a portion of a system management unit according to some embodiments.

FIG. 5 is a flow diagram of a method for selectively scheduling an application phase to a component of a processing device according to some embodiments.

FIG. 6 is a flow diagram illustrating a method for designing and fabricating an integrated circuit device implementing at least a portion of a component of a processing system in accordance with some embodiments.

### DETAILED DESCRIPTION

The number of thermal emergencies and the rate of temperature-induced aging in processing devices such as SOCs can be reduced by selectively scheduling applications to components of the processing device based on comparisons of predicted thermal impacts of executing the applications on the different components. As used herein, the “thermal impact” of an application on a component refers to the magnitude of increase of a temperature or the rate of increase of the temperature of the component (or one or more neighboring components) while the component is executing the application. The thermal impact of an application depends on characteristics of the application such as whether the application is compute intensive or memory bounded. The thermal impact also depends on the performance state of the component, e.g., whether the component is operating at a relatively high operating voltage/frequency or a lower operating voltage/frequency. The thermal impact also depends on the thermodynamic properties of the component, the layout of components on the processing device, and the computational efficiency of the application on the component. The thermal impact of an application on a component may be predicted based on past thermal profiles of the application on different components, prior numbers or frequencies of thermal emergencies while executing the application on different components, predicted thermal rise times during execution of the application on different components, thermal properties of the components, the layout of the components, and the like. Active and idle phase duration histories may also be used to predict the thermal impact of an application.

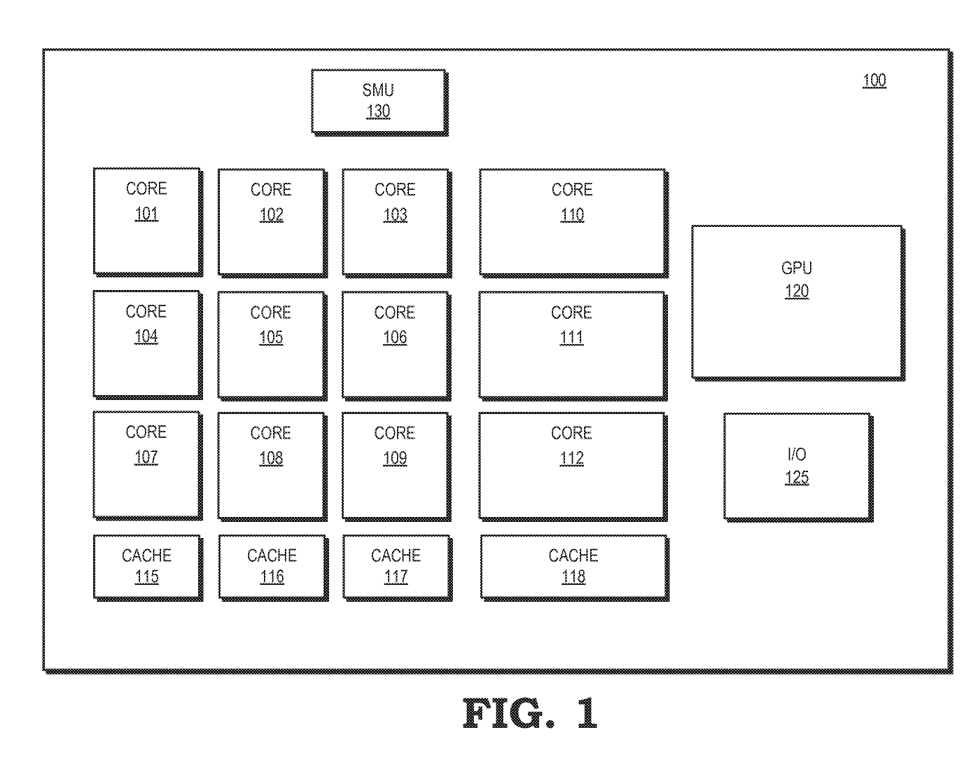

FIG. 1 is a block diagram of a processing device 100 in accordance with some embodiments. The processing device 100 is a heterogeneous processing device that includes multiple processor cores 101, 102, 103, 104, 105, 106, 107, 108, 109, 110, 111, 112 (collectively referred to herein as “the processor cores 101-112”) that can independently execute instructions concurrently or in parallel. In some embodiments, the processor cores 101-112 may be associated with one or more CPUs (not shown in FIG. 1). The processor cores 101-112 are associated with one or more caches 115, 116, 117, 118 that are collectively referred to herein as “the caches 115-118”. Some embodiments of the caches 115-118 may include an L2 cache for caching instructions or data, one or more L1 caches, or other caches. Some embodiments of the caches 115-118 may be subdivided into an instruction cache and a data cache.

The processor cores 101-112 or the caches 115-118 may have different sizes. For example, the processor cores 101-109 may be smaller than the processor cores 110-112 and the caches 115-117 may be smaller than the cache 118. The size of a cache is typically determined by the number or length of lines in the cache. The size of a processor core may be determined by the instructions per cycle (IPCs) that can be performed by the processor core, the size of the instructions (e.g., single instructions versus very long instruction words, VLIWs), the size of caches 115-118 implemented in or associated with the processor cores 101-112, whether the processor core supports out-of-order instruction execution (larger) or in-order instruction execution (smaller), the depth of an instruction pipeline, the size of a prefetch engine, the size or quality of a branch predictor, whether the processor core is implemented using an x86 instruction set architecture (larger) or an ARM instruction set architecture (smaller), or other characteristics of the processor cores 101-112. The larger processor cores 110-112 may consume more area on the die and may consume more power relative to the smaller processor cores 101-109. The number or size of processor cores in the processing device 100 is a matter of design choice. Some embodiments of the processing device 100 may include more or fewer processor cores 101-112 and the processor cores 101-112 may have a different distribution of sizes.

A graphics processing unit (GPU) 120 is also included in the processing device 100 for creating visual images intended for output to a display, e.g., by rendering the images on a display at a frequency determined by a rendering rate. Some embodiments of the GPU 120 may include multiple cores, a video frame buffer, or cache elements that are not shown in FIG.1 interest of clarity. In some embodiments, the GPU 120 may be larger than some or all of the processor cores 101-112. For example, the GPU 120 may be configured to process multiple instructions in parallel, which may lead to a larger GPU 120 that consumes more area and more power than some or all of the processor cores 101-112.

The processing device 100 includes an input/output (I/O) engine 125 for handling input or output operations associated with elements of the processing device such as keyboards, mice, printers, external disks, and the like.

The processor cores 101-112 and the GPU 120 can perform operations such as executing instructions from an application or a phase of an application. As used herein, the term “application phase” refers to a portion of an application that can be scheduled for execution on a component of the processing device 100 independently of scheduling other portions, or other application phases, of the application. The size of an application phase may range from a single instruction to all of the instructions in the application. An application phase may correspond to an application kernel, which refers to a particular portion of an application defined by the programmer, such as a function, a subroutine, a code block, and the like. Each application phase may run for a different duration, exhibit different mixes of active events and idle events, and have different computational intensities or be more or less memory bounded. Application phases may also have different thermal properties or characteristics. For example, different application phases may induce different thermal rise times in the processor cores 101-112 or the GPU 120, may have different thermal intensities, or may exhibit different thermal profiles when executed on the different processor cores 101-112 or the GPU 120, as discussed herein.

The processor cores 101-112 the GPU 120, the I/O engine 125 or other components in the processing device 100 may have different thermal densities or thermal sensitivities. As used herein, the term “thermal density” indicates the amount of power dissipated per unit area or the amount of heat dissipation per unit area at a location or by a component in the processing device 100. As used herein, the term “thermal sensitivity” indicates how sensitive the temperature at a particular location or in a particular component is to changes in the thermal density in a region proximate the location. For example, a region with a higher thermal sensitivity may rise to a higher temperature than a region with a lower thermal sensitivity when the two regions are exposed to the same thermal density. The thermal density or thermal sensitivity of a portion of the processing device 100 may depend on a variety of factors that may in turn interact with each other. The following discussion provides examples of factors that may affect the thermal density or thermal sensitivity but thermal densities or thermal sensitivities in some embodiments of the processing device 100 may be influenced by other factors or other combinations of factors or interactions between factors.

The thermal density or the thermal sensitivity of components such as the processor cores 101-112 or the GPU 120 may depend on the size of the processor cores 101-112 or the size of the GPU 120. For example, the thermal density or thermal sensitivity of the smaller processor cores 101-109 may be smaller (or larger) than the thermal density or thermal sensitivity of the larger processor cores 110-112. Some embodiments of the GPU 120 may be more thermally efficient and therefore have lower thermal densities or thermal sensitivities than other entities in the processing device 100 such as the processor cores 101-112. Thus, the GPU 120 may operate at a lower temperature than the processor cores 101-112 when the GPU 120 and the processor cores 101-112 are consuming the same amount of power.

The thermal density or the thermal sensitivity of components such as the processor cores 101-112 or the GPU 120 may also depend on the distribution or layout of the processor cores 101-112 or the GPU 120 in the processing device 100. In some embodiments, thermal sensitivity is larger in portions of the processing device 100 that include a larger density of circuits because changes in the power dissipated in higher density circuits can lead to more rapid changes in the local temperature. The thermal sensitivity may also be larger at the center of a substrate because circuits in the center of the substrate may not be as close to external heat sinks (if present) and therefore do not dissipate heat as efficiently as circuits near the edge of the substrate that are closer to the external heat sinks For example, the thermal sensitivity of the processor core 105 may be larger than the thermal sensitivity of the processor core 101. Proximity to components that have a relatively low thermal density/sensitivity may also decrease the thermal density/sensitivity of a component. For example, the thermal sensitivity of the processor core 109 may be lower than the thermal sensitivity of the processor core 103 because the processor core 109 is near the cache 117, which has a lower thermal sensitivity. Stacking multiple substrates in a 3-dimensional configuration may also affect the thermal density and thermal sensitivity because heat can be efficiently conducted between the stacked substrates.

The thermal density or the thermal sensitivity of components such as the processor cores 101-112 or the GPU 120 may also depend on the workload or workloads being executed by the processor cores 101-112 or the GPU 120. For example, the thermal densities of a pair of adjacent components such as the processor cores 101-102 may be relatively high if they are independently processing two high-power workloads and there is no resource contention between the workloads being processed on the different compute units so the processor cores 101-102 are able to retire instructions at a high rate. The temperatures of the compute units may therefore increase while processing the high-power workloads due to the relatively high heat dissipation, potentially leading to thermal emergencies or thermal throttling of the workloads, e.g., by reducing the operating frequency or operating voltage. For another example, the thermal densities of the processor cores 101 and 109 may be relatively lower than the previous example even if they are independently processing the same two high-power workloads because the heat can be efficiently dissipated by other structures such as the cache 117, idle processor cores 102, 104, 105, or external heat sinks

The thermal density or the thermal sensitivity of components such as the processor cores 101-112 or the GPU 120 may also depend on whether the workload or workloads being executed by the processor cores 101-112 or the GPU 120 are computationally intensive or memory bounded. For example, a processor core 101 that is executing a computationally intensive application phase may retire a relatively large number of instructions per cycle and may therefore dissipate a larger amount of heat. The processor core 101 may therefore exhibit a high thermal density or thermal sensitivity. For another example, an application phase that is memory bounded may exhibit relatively short active periods interspersed with relatively long idle periods and may therefore dissipate a smaller amount of heat. A processor core running the memory bounded application phase may therefore exhibit a low thermal density or thermal sensitivity.

The thermal density or the thermal sensitivity of components such as the processor cores 101-112 or the GPU 120 may also depend on the performance state of the processor cores 101-112 or the GPU 120. For example, the thermal density or thermal sensitivity of the processor core 101 may be higher than the thermal density or thermal sensitivity of the processor core 102 if the processor core 101 is operating at a higher voltage or frequency than the processor core 102. For another example, the thermal density or thermal sensitivity of the processor core 101 may increase (or decrease) in response to a change in the performance state that causes the operating voltage or frequency of the processor core 101 to increase (or decrease).

Some embodiments of the processing device 100 may implement a system management unit (SMU) 130 that may be used to carry out policies set by an operating system (not shown in FIG. 1) of the processing device 100. The operating system may be implemented using one or more of the processor cores 101-112. Some embodiments of the SMU 130 may be used to manage thermal and power conditions in the processing device 100 according to policies set by the operating system and using information that may be provided to the SMU 130 by the operating system, such as a thermal history associated with an application being executed by one of the components of the processing device 100, thermal sensitivities of the components, and a layout of the components in the processing device 100, as discussed herein. The SMU 130 may therefore be able to control power supplied to entities such as the processor cores 101-112 or the GPU 120, as well as adjusting operating points of the processor cores 101-112 or the GPU 120, e.g., by changing an operating frequency or an operating voltage supplied to the processor cores 101-112 or the GPU 120. The SMU 130 or portions thereof may therefore be referred to as a power management unit in some embodiments.

Some embodiments of the SMU 130 may predict the thermal impact of scheduling an application phase to different components in the processing device 100 and may then selectively schedule the application phase to one of the components based on a comparison of the predicted thermal impacts on the different components. For example, the SMU 130 may predict the thermal impact of an application phase by predicting the magnitude of increase of a temperature or the rate of increase of the temperature of the component (or one or more neighboring components) while the component is executing the application phase. The thermal impact of the application phase may depend on characteristics of the application phase such as whether the application phase is computationally intensive or memory bounded, the thermodynamics of the components (e.g., the GPU 120 may be more thermally efficient than the processor cores 101-112), the layout of the components in the processing device 100 (which may determine the magnitude of thermal coupling effects), the computational efficiency of the application phase (e.g., an application phase with many branch instructions may be operated less efficiently on the GPU 120 even though the GPU 120 may be cooler than other components while executing the application phase), or other characteristics. The SMU 130 may therefore predict the thermal impacts based on a thermal history associated with the application phase, thermal sensitivities of the components of the processing device 100, or a layout of the plurality of components in the processing device 100.

Selectively scheduling application phases may be used to reduce thermal peaks in components of the processing device 100 and reduce the likelihood of thermal emergencies. For example, if the predicted thermal impact of scheduling the application phase on a processor core 105 is larger than or comparable to a predicted thermal impact of scheduling the same application phase on the processor core 102, the SMU 130 may selectively schedule the application phase to the processor core 102 to smooth out temperature peaks in the thermal density map associated with the processor core 105. For another example, an application phase may be rescheduled or moved from a high temperature processor core 105 to a low temperature processor core 102 if the predicted thermal impact of the application phase is high enough that rescheduling or moving the application phase may reduce the temperature of the processor core 105.

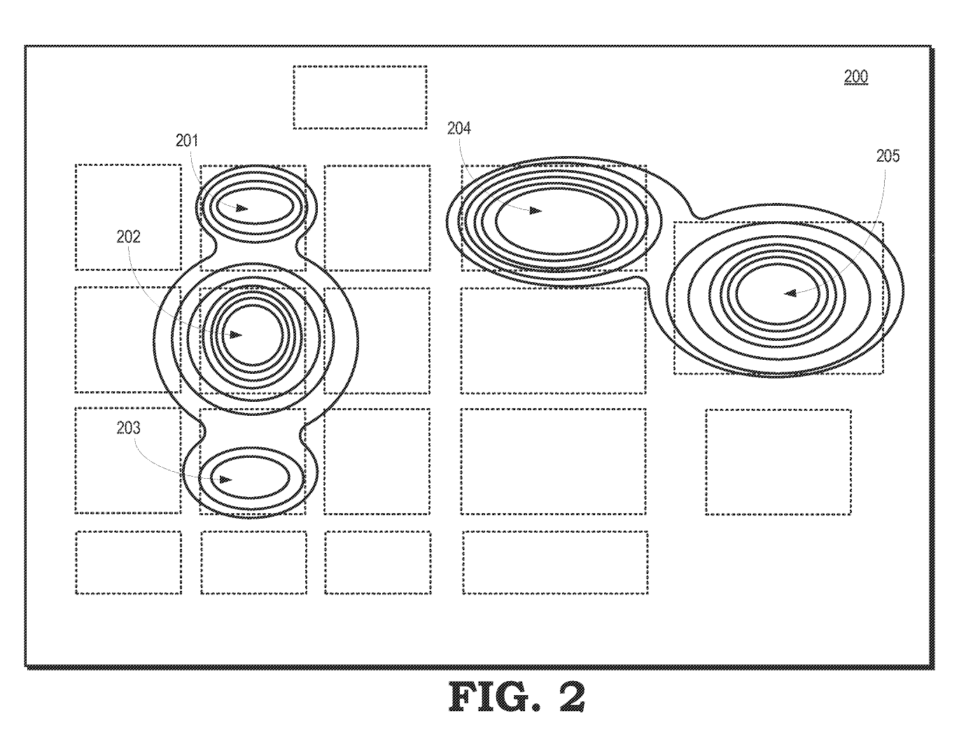

FIG. 2 is a contour plot of a thermal density map 200 for a processing device such as the processing device 100 shown in FIG. 1 according to some embodiments. Locations of the processor cores 101-112, the caches 115-118, the GPU 120, the I/O engine 125, and the SMU 130 are indicated by dashed lines to facilitate comparison with the processing device 100 shown in FIG. 1. Some embodiments of the thermal density map 200 may be generated using sensor monitors, temperature monitors, or other devices that can be used to measure or infer the temperature at different locations on the processing device 100. The thermal density map 200 (or information derived therefrom) may be provided to a system management unit such as the SMU 130 shown in FIG. 1 to facilitate selective scheduling of application phases, as discussed herein.

The contours of the thermal density map 200 indicate one or more thermal conditions such as the presence of thermal density peaks 201, 202, 203, 204, 205 (collectively referred to as “the thermal density peaks 201-205”) associated with the processor cores 102, 105, 108, 110 and the GPU 120. The thermal density peaks 201-205 may be represented as temperature peaks. For example, each contour may indicate a difference of 0.5° C. and so the processor core 105 may be at a temperature that is approximately 1.5° C. higher than the temperature of the processor core 102, which may be approximately 2° C. higher than the temperature of the processor core 101. For another example, the GPU 120 may be approximately 3-4° C. higher than the temperature of the processor core 112. Some embodiments of the thermal density map 200 may also indicate absolute temperatures. For example, the temperature of the processor core 101 may be approximately 95° C. and the temperature of the processor core 102 may be approximately 97° C.

The thermal density map 200 also indicates that temperature peaks can influence the temperature in adjacent components. For example, the peak 202 in the thermal density map 200 over the processor core 105 extends into the adjacent processor cores 102, 104, 106, 108 because of thermal coupling effects. The temperatures in the adjacent processor cores 102, 104, 106, 108 may therefore be determined by application phases that have been scheduled to the processor core 105 as well as application phases that have been scheduled to the adjacent processor cores 102, 104, 106, 108.

As discussed herein, the thermal density peaks 201-205 may at least in part be the result of the different thermal impacts of the application phases that are being executed on the processor cores 102, 105, 108, 110 or the GPU 120. The SMU 130 shown in FIG. 1 may therefore use information in the thermal density map 200, such as the locations or amplitudes of the thermal density peaks 201-205, to schedule application phases based upon their predicted thermal impacts to reduce or eliminate some of the thermal peaks 201-205 in the thermal density map 200. Some embodiments of the SMU 130 may also redistribute application phases that were previously scheduled to be executed on one or more of the processor cores 102, 105, 108, 110 or the GPU 120 to other processor cores 101-112 or the GPU 120 based on the predicted thermal impacts of the application phases. Redistribution of the application phases (which may also be referred to as load-balancing) may reduce some or all of the thermal density peaks 201-205 or reduce the likelihood of thermal emergencies and the processing device 100.

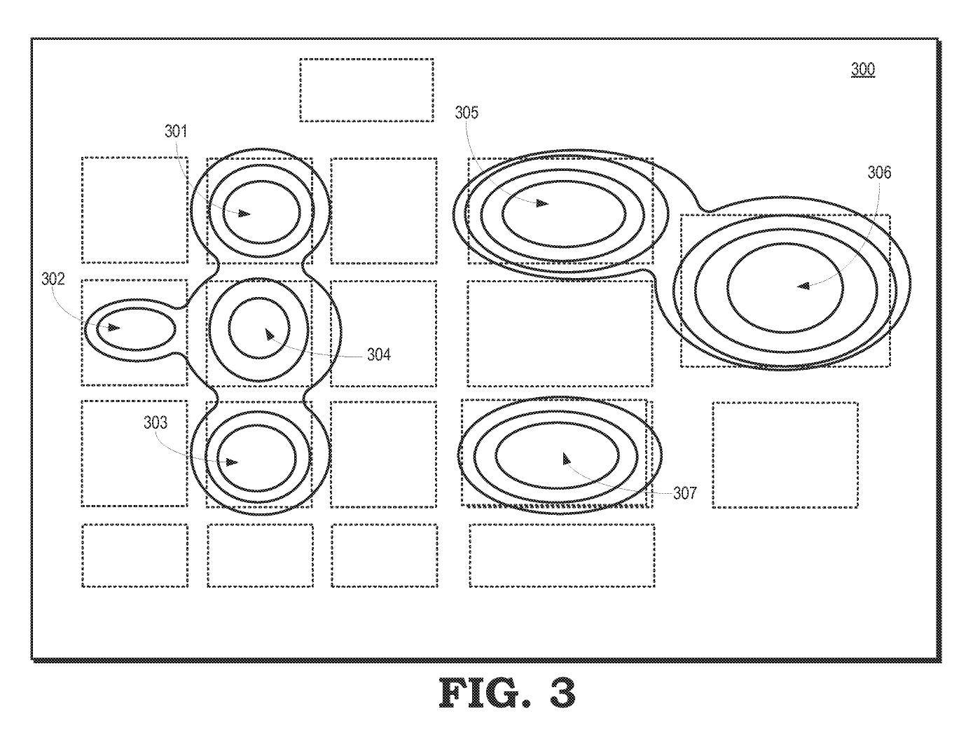

FIG. 3 is a contour plot of a thermal density map 300 for a processing device such as the processing device 100 shown in FIG. 1 according to some embodiments. Locations of the processor cores 101-112, the caches 115-118, the GPU 120, the I/O engine 125, and the SMU 130 are indicated by dashed lines to facilitate comparison with the processing device 100 shown in FIG. 1. Some embodiments of the thermal density map 300 may be generated using sensor monitors, temperature monitors, or other devices that can be used to measure or infer the temperature at different locations on the processing device 100. The thermal density map 300 (or information derived therefrom) may be provided to a system management unit such as the SMU 130 shown in FIG. 1 to facilitate selective scheduling of application phases, as discussed herein.

The thermal density map 300 depicts the thermal state of the processing device 100 after the SMU 130 has scheduled or redistributed application phases. For example, the thermal density map 300 depicts thermal peaks 301, 302, 303, 304, 305, 306, 307 (collectively referred to herein as “the thermal peaks 301-307”). The scheduling or redistribution is performed based on predicted thermal impacts and the conditions represented by the thermal density map 200 shown in FIG. 2. For example, the SMU 130 may schedule or redistribute application phases to attempt to reduce the thermal peak 202 associated with the processor core 105 (as shown in FIG. 2) to the thermal peak 304 (as shown in FIG. 3). Thus, one or more application phases may be scheduled to the processor core 104 or redistributed to the processor core 104, e.g., from the processor core 105. For another example, the SMU 130 may schedule or redistribute application phases to reduce the thermal peaks associated with the processor core 110 or the GPU 120 shown in the thermal density map 200. Thus, one or more application phases may be scheduled to the processor core 112 or redistributed to the processor core 112, e.g., from the processor core 110 or the GPU 120. Consequently, the temperature distribution indicated by the thermal density map 300 is smoother and has less pronounced thermal density peaks than the thermal density map 200. For example, the processor cores 102, 105, 108 are operating at approximately the same temperature and the processor core 104 is approximately 0.5° C. cooler than the processor cores 102, 105, 108. For another example, the processor core 110 and the GPU 120 are operating at approximately the same temperature and the processor core 112 is approximately 0.5° C. cooler than the processor core 110 or the GPU 120.

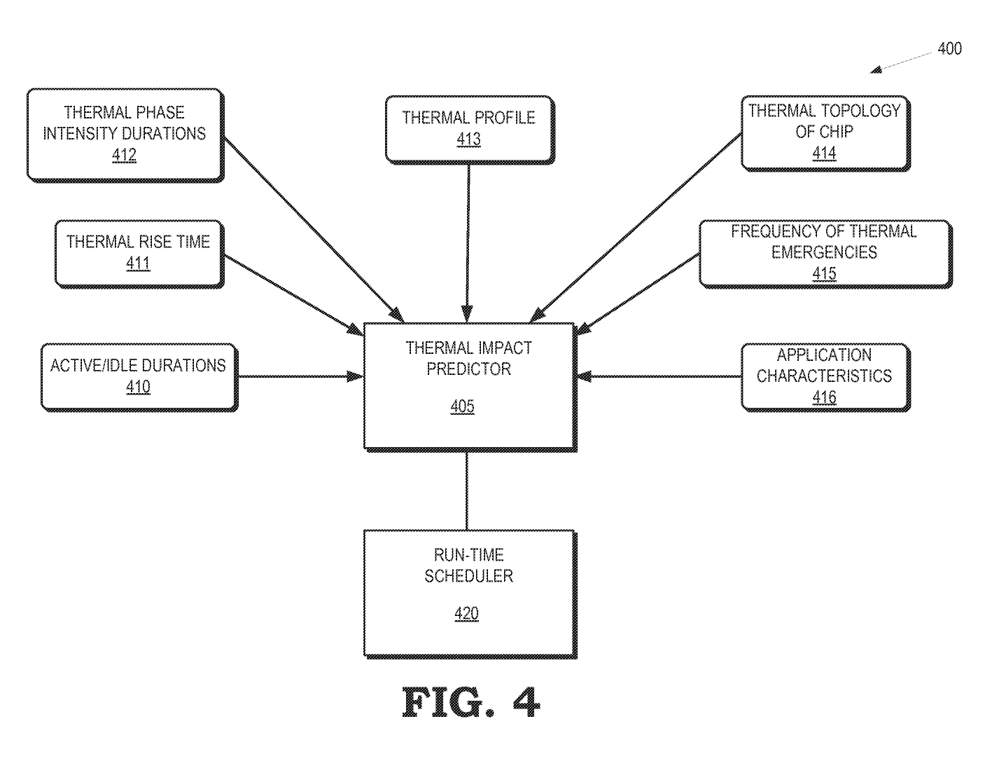

FIG. 4 is a block diagram of a portion 400 of an SMU such as the SMU 130 shown in FIG. 1 according to some embodiments. The portion 400 of the SMU includes a thermal impact predictor 405 that is used to predict the thermal impact of scheduling an application phase to one or more components of a processing device such as the processing device 100 shown in FIG. 1. The thermal impact predictor 405 may be implemented in software, firmware, hardware, or combinations thereof. The thermal impact predictor 405 receives input that can be used to predict the thermal impact of scheduling an application phase to various components. The input may be received from the operating system, the application or application phase, registers, counters, stored values of activity factors, and the like. Examples of the inputs that may be received by the thermal predictor include the inputs 410, 411, 412, 413, 414, 415, 416 (collectively referred to as “the inputs 410-416”). Some embodiments of the thermal impact predictor 405 may receive subsets of the inputs 410-416 or may receive additional inputs that can also be used to predict the thermal impact of the application phase.

In some embodiments, the thermal impact predictor 405 receives input 410 that indicate durations of one or more active events or idle events associated with the application phase. For example, the input 410 may indicate predicted durations of active events or idle events for the application phase. The durations may be predicted using histories of active events or idle events, e.g., using an average of durations of previous active or idle events, a linear predictor that predicts subsequent durations based on previous durations, a weighted average of previous active or idle events, a filtered linear predictor that predicts subsequent durations based on a subset of previous durations, a two-level adaptive global predictor that predicts durations using a pattern history of active or idle events, a two-level adaptive local predictor that predicts durations using a pattern history of active or idle events for the application phase, a tournament predictor that selects a prediction from among the predictions made by other techniques, and the like. The durations may be predicted on a per-process basis, a per-application phase basis, or a global basis for a group of processes or application phases. These prediction techniques may also be used to predict values of other quantities discussed herein.

The thermal impact predictor 405 may also receive an input 411 that indicates a thermal rise time associated with the application phase. The thermal rise time input 411 may indicate a predicted thermal rise time for the application phase on a particular component (e.g., the input 411 may indicate different thermal rise times for small processor cores and large processor cores) or an average over all components. The thermal rise time may indicate a time or a timescale for raising the temperature of a component by a predetermined number of degrees or for raising the temperature of the component above a predetermined threshold. The thermal rise time associated with the application phase may be determined by storing a history of previous measurements of the thermal rise time during execution of the application phase on one or more components, as discussed below.

The thermal impact predictor 405 may also receive an input 412 that indicates one or more durations of different thermal phase intensities. Some embodiments of the application phase may generate larger or smaller thermal intensities during different portions of the application phase. For example, the application phase may initially run at a low thermal intensity, which may increase to a larger thermal intensity as execution of the instructions in the application phase progresses. The input 412 may therefore indicate the durations of different thermal phase intensities associated with the application phase.

The thermal impact predictor 405 may also receive an input 413 that indicates a predicted thermal profile of the application phase. The thermal profile input 413 may indicate the predicted temperature of a component as a function of time during execution of the application phase. Thus, in some embodiments, the thermal profile may be used to estimate other thermal properties such as the thermal rise time or the thermal phase intensity durations. The thermal profile input 413 may indicate a predicted thermal profile based on an average or other statistical combination of previous measurements of the thermal profile associated with the application phase. The thermal profile may be predicted for specific components (e.g., different thermal profiles may be predicted for small processor cores and large processor cores) or it may be predicted based on average over different types of components.

The thermal impact predictor 405 may also receive an input 414 that indicates a thermal topology of a chip that includes the processing device. Some embodiments of the input 414 may include information indicating a thermal layout or thermal footprint of the processing device on the chip. For example, the input 414 may indicate locations of each of the components, thermal sensitivities of each of the components, characteristics of thermal interactions between the components, and the like. Some embodiments of the input 414 may also include information representing a thermal density map such as the thermal density maps 200, 300 shown in FIG. 2 and FIG. 3, respectively. Some embodiments of the input 414 may also include information indicating performance states of one or more components. For example, the input may indicate an operating voltage or operating frequency of one or more of the components of the processing device. The information indicating the thermal layout, the thermal density map, and the performance states may not be independent, e.g., the thermal sensitivity of a component may be a function of the temperature of the component or neighboring components, which may in turn be a function of the performance states of one or more components.

The thermal impact predictor 405 may also receive input 415 that indicates a frequency of thermal emergencies associated with the processing device. A thermal emergency may occur when a temperature of a component in the processing device exceeds a threshold temperature. The threshold temperatures may be determined theoretically, empirically, or experimentally and may represent temperatures at which the component may be damaged or impaired by temperatures above the threshold. Some embodiments of the processing device may maintain and update a record of thermal emergencies that occur during operation of the processing device. The thermal emergencies may be associated with particular components of the processing device or a global record of all thermal emergencies may be maintained.

The thermal impact predictor 405 may also receive input 416 indicating characteristics of the application or application phase. In some embodiments, the application characteristics include information indicating whether the application or application phase is computationally intensive or memory bounded. The application characteristics may also include information indicating the computational efficiency of the application or application phase. For example, the application characteristics may indicate whether the application phase includes a large number of branch instructions, which may indicate that the application phase has better performance on processor cores but may have a smaller thermal impact on GPUs.

The thermal impact predictor 405 may use the inputs 410-416 to generate predictions of the thermal impact of the application phase on different components of the processing device. For example, the thermal impact predictor 405 may predict the thermal impacts of scheduling the application phase for execution on one or more small processor cores such as the small processor cores 101-109, one or more large processor cores such as the large processor cores 110-112, and a GPU such as the GPU 120 shown in FIG. 1. The predicted thermal impact may be represented as a predicted change in a temperature of the component, a predicted rate of change of a temperature of the component, and the like. The thermal impact predictor 405 may therefore generate a signal representative of the predicted change in temperature or the predicted rate of change. Some embodiments of the thermal impact predictor 405 may predict how quickly the application phase may heat each component to its temperature limit if the application were to be scheduled for execution on the component. The thermal impact for each combination of an application phase and a component may therefore be represented by a time value such that larger thermal impacts (i.e., more rapid rise times) are represented by smaller time values and smaller thermal impacts (i.e., less rapid rise times) are represented by larger time values. Other representations of the thermal impact may also be generated by the thermal impact predictor 405.

A runtime scheduler 420 may receive signals from the thermal impact predictor 405 and selectively schedule the application phase to a component of the processing device based on the predicted thermal impacts. Outputs generated by the runtime scheduler 420 may include a size of an application phase or a portion of the application phase that is to be scheduled to execute on a component, an indication of the component that the application phase is scheduled to be executed on, an indication of a distribution of different application phases that are scheduled for execution on different components, and the like.

Some embodiments of the runtime scheduler 420 selectively schedule the application phase to a component by comparing the predicted thermal impacts of scheduling the application phase to different components. For example, processor cores may have high thermal densities or thermal sensitivities compared to GPUs and consequently processor cores may heat up more quickly than GPUs when executing the same application phase. The runtime scheduler 420 may therefore selectively schedule application phases to the processor core if the estimated thermal impact indicates that the application phase can complete execution within the predicted thermal time constant for the processor core, thereby maximizing performance. The runtime scheduler 420 may also selectively schedule the application phases to the GPU if they are not predicted to complete within the predicted thermal time constant of the processor core. For another example, the runtime scheduler 420 may intersperse high thermal impact application phases on one processor core with low thermal impact application phases on an adjacent processor core so that the cooler core can absorb some of the heat from the hotter core, e.g., when the GPUs are running a very high compute intensive application phase, the processor core(s) can run a different, highly memory intensive application phase so that its thermal impact is lower than the GPU and does not cause detrimental effects on the already hot GPU.

Some embodiments of the runtime scheduler 420 may selectively schedule the application phases using the predicted thermal impact along with a floor plan or a thermal density map of the processing device. For example, the runtime scheduler 420 may make load balancing decisions by comparing the predicted thermal impacts of scheduling an application phase for execution on different components and comparing the thermal densities of the different components as indicated in the thermal density map. In order to smooth peaks in the thermal density map, the application phase may be scheduled to a component with a low thermal density if it has a high thermal impact or it may be scheduled to a component with a high thermal density if it has a low thermal impact. Some embodiments of the runtime scheduler 420 may also selectively schedule the application phases to different sizes of components of the processing device. For example, the runtime scheduler 420 may selectively schedule a long duration high thermal impact phase for execution on a larger processor core with low thermal density whereas the runtime scheduler 420 may selectively schedule a low thermal impact phase to run on a smaller processor core with high thermal density.

Some embodiments of the runtime scheduler 420 may also selectively schedule the application phases based on other algorithms or policies that may be constructed to satisfy various thermal requirements of the processing device. For example, the runtime scheduler 420 may selectively schedule the application phases to produce alternating high and low thermal impact phases, which may allow the processing device to cool down after the high thermal impact phase so that subsequent high thermal impact phases may achieve higher performance by being run on a cool processing device. For example, if the processing device is relatively cool, the high thermal impact phase can be scheduled to components that are operating in higher performance states, e.g., at higher operating voltages or operating frequencies. Since the processing device started at a lower temperature, the high thermal impact phase may execute in the higher performance state without raising the temperature of one or more components above their temperature thresholds.

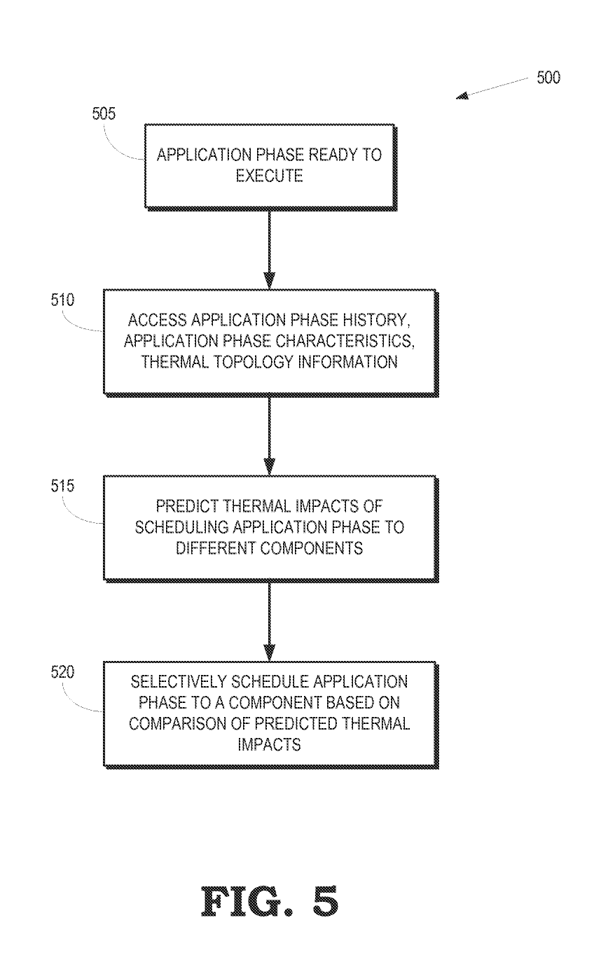

FIG. 5 is a flow diagram of a method 500 for selectively scheduling an application phase to a component of a processing device according to some embodiments. The method may be implemented in embodiments of the processing device 100, e.g., in an SMU such as the SMU 130 shown in FIG. 1. At block 505, the SMU determines that an application phase is ready to be executed on one of the components of the processing device. For example, an operating system may provide a signal to the SMU indicating that the application phase is ready for execution. At block 510, the SMU accesses an application phase history, information indicating characteristics of the application phase, and thermal topology information associated with the processing device. Examples of the information that may be included in the application phase history, the characteristics of the application phase, or the thermal topology are provided herein. At block 515, the SMU predicts the thermal impacts of scheduling the application phase to different components in the processing device. At block 520, the SMU selectively schedules the application phase to one of the components based on the comparison of the predicted thermal impacts.

In some embodiments, the apparatus and techniques described above are implemented in a system comprising one or more integrated circuit (IC) devices (also referred to as integrated circuit packages or microchips), such as the processing device described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

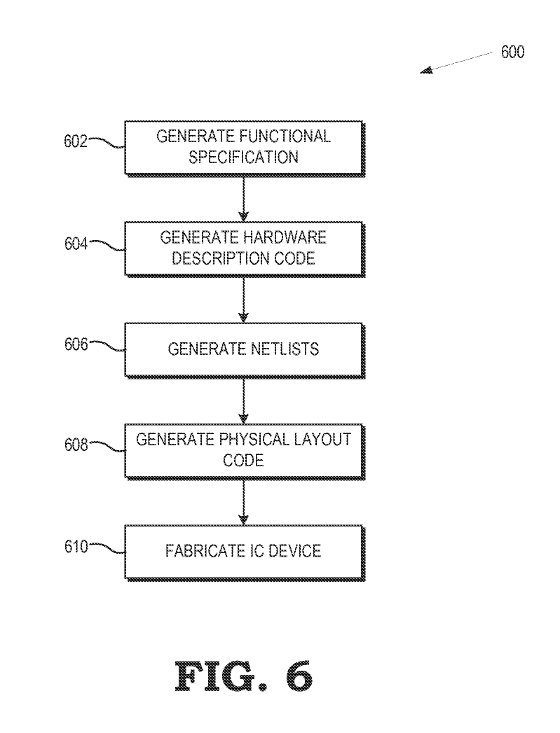

FIG. 6 is a flow diagram illustrating an example method 600 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selectively scheduling an application phase to one of a plurality of components of a processing device based on at least one comparison of predictions of a plurality of thermal impacts of executing the application phase on each of the plurality of components.

2. The method of claim 1, further comprising:
generating the predictions of the plurality of thermal impacts based on at least one of a thermal history associated with the application phase, thermal sensitivities of the plurality of components, and a layout of the plurality of components in the processing device.

3. The method of claim 2, wherein generating the predictions of the plurality of thermal impacts based on the thermal history associated with the application phase comprises generating the predictions of the plurality of thermal impacts based on at least one of predicted thermal rise times, predicted durations of the application phase, and predicted thermal profiles associated with the application phase for each of the plurality of components.

4. The method of claim 2, wherein generating the predictions of the plurality of thermal impacts based on the layout of the plurality of components comprises predicting the thermal impacts based on proximity of the plurality of components to heat sinks or other components.

5. The method of claim 1, further comprising:
generating the predictions of the plurality of thermal impacts based on at least one frequency of thermal emergencies associated with the plurality of components.

6. The method of claim 1, further comprising:
generating the predictions of the plurality of thermal impacts based on at least one of predicted durations of active events during the application phase, predicted durations of idle events during the application phase, and whether the application phase is compute intensive or memory bounded.

7. The method of claim 1, wherein selectively scheduling the application phase to one of the plurality of components comprises selectively scheduling the application phase to one of the plurality of components based on a thermal density map of the processing device.

8. The method of claim 7, wherein selectively scheduling the application phase comprises scheduling the application phase to a first component that is at a lower temperature than a second component.

9. A processing device comprising:
a plurality of components; and
a system management unit to selectively schedule an application phase to one of the plurality of components based on at least one comparison of predictions of a plurality of thermal impacts of executing the application phase on each of the plurality of components.

10. The processing device of claim 9, wherein the system management unit is to generate the predictions of the plurality of thermal impacts based on at least one of a thermal history associated with the application phase, thermal sensitivities of the plurality of components, and a layout of the plurality of components in the processing device.

11. The processing device of claim 10, wherein the system management unit is to generate the predictions of the plurality of thermal impacts based on at least one of predicted thermal rise times, predicted durations of the application phase, and predicted thermal profiles associated with the application phase for each of the plurality of components.

12. The processing device of claim 10, wherein the system management unit is to predict the thermal impacts based on proximity of the plurality of components to heat sinks or other components.

13. The processing device of claim 10, wherein the system management unit is to generate the predictions of the plurality of thermal impacts based on at least one frequency of thermal emergencies associated with the plurality of components.

14. The processing device of claim 10, wherein the system management unit is to generate the predictions of the plurality of thermal impacts based on at least one of predicted durations of active events during the application phase, predicted durations of idle events during the application phase, and whether the application phase is compute-intensive or memory-bounded.

15. The processing device of claim 9, wherein the system management unit is to selectively schedule the application phase to one of the plurality of components based on a thermal density map of the processing device.

16. The processing device of claim 15, wherein the system management unit is to schedule the application phase to a first component that is at a lower temperature than a second component.

17. A non-transitory computer readable storage medium embodying a set of executable instructions, the set of executable instructions to manipulate at least one processor to:
selectively schedule an application phase to one of a plurality of components of a processing device based on at least one comparison of predictions of a plurality of thermal impacts of executing the application phase on each of the plurality of components.

18. The non-transitory computer readable storage medium of claim 17, further comprising executable instructions to manipulate the at least one processor to:
generate the predictions of the plurality of thermal impacts based on at least one of a thermal history associated with the application phase, thermal sensitivities of the plurality of components, and a layout of the plurality of components in the processing device.

19. The non-transitory computer readable storage medium of claim 17, further comprising executable instructions to manipulate the at least one processor to:
generate the predictions of the plurality of thermal impacts based on at least one of a frequency of thermal emergencies, predicted durations of active events during the application phase, predicted durations of idle events during the application phase, and whether the application phase is compute-intensive or memory-bounded.

20. The non-transitory computer readable storage medium of claim 17, further comprising executable instructions to manipulate the at least one processor to:
selectively schedule the application phase to one of the plurality of components based on a thermal density map of the processing device.
